(19) United States
(12) Patent Application Publication
(10) Pub. No.: US 2025/0229748 A1
(43) Pub. Date: Jul. 17, 2025

(54) Vehicle Leveling System and Method of Achieving Absolute Flatness

(71) Applicant: FBA Operating Co., Dallas, TX (US)

(72) Inventors: Allen Nejah, San Jose, CA (US); David Schumann, Apache Junction, AZ (US); Barbara Timm-Brock, San Jose, CA (US)

(73) Assignee: FBA Operating Co., Dallas, TX (US)

(21) Appl. No.: 18/414,778

(22) Filed: Jan. 17, 2024

(51) Int. Cl. B60S 9/02; G01C 19/32; G01C 19/48; G01D 7/12

(52) U.S. Cl. CPC B60S 9/02; G01C 19/32; G01C 19/48; G01D 7/12

(57) ABSTRACT

A vehicle leveling system has a sensor for sensing a reference state of a vehicle and a level state of the vehicle. The reference state is subtracted from the level state to determine a difference angle. The reference state is absolute flat or other reference angle. A smart device is in communication with the sensor to zero out the difference angle and level the vehicle. The smart devices provide feedback to a user to adjust orientation of the vehicle as to zero out the difference angle and level the vehicle. The feedback can be an audible or human sensory feedback, such as voice or tones. A plurality of jacks is used to level the vehicle by zeroing out the difference angle. The jacks can be controlled by the smart device or sensor. The sensor has a gyroscope providing multiple angles of orientation.

### FIELD OF THE INVENTION

The present invention generally relates to a vehicle leveling system for leveling a vehicle, and more particularly, to a leveling system for leveling a vehicle, such as a recreational vehicle, to achieve absolute flatness while providing audible or other human sensory feedback.

### BACKGROUND

Whether in a storage or use state, a recreational vehicle (RV) should be leveled for both practical and technical reasons. Practical reasons include a level floor, proper door swings, stove, and sink use, as well as many others. Technical reasons include proper operation of the ammonia-based refrigerator, level holding tanks for proper level detection by electrical system for the proper operation of the plumbing and various other systems. Some higher-end Class A RVs have onboard leveling systems that utilize digital sensors and hydraulic jacks, but most do not have any native leveling capability beyond the raising and lowering of the front of the RV using manual or electric jacks. Level indicators are generally bubble levels attached to both the side and front or rear of the RV. In addition, there are many other vehicles and trailers that require a level position to operate properly such as food vending trucks, mobile medical trailers, transport trailers, and in some cases heavy equipment.

The described device provides leveling indication for the two main axes of the RV (side-to-side and front-to-back). For the purposes of describing both the typical and proposed leveling method, pitch will be defined as the angle of the RV from front to back, and roll will be defined as the angle of the RV from side to side.

Once the RV has been moved into the desired location and orientation for use, the driver must exit the RV or tow vehicle to inspect the current level condition of the RV, often by using the bubble levels attached to the RV. The first step can be to level the roll of the RV. Typically, this is done by driving or towing the appropriate RV wheels onto a board, block or other object to raise one side of the RV closer to level. Since the bubble levels being used do not give any exact information regarding the amount the RV is out of level, it is at best an educated guess to determine just how high the appropriate wheels must be raised. Typically, a trial-and-error system, requiring the driver to make multiple attempts at raising the appropriate wheels the necessary amount to achieve a level position. Each attempt requires the driver to get back into the vehicle to move the wheels off of the previously placed object being used to raise wheels, exit the vehicle to add or take away from the height of the object being used to raise the wheels, enter the vehicle again to drive or tow the wheels back onto the object being used to raise the wheels and finally exiting the vehicle again to check the new roll orientation relative to level. It is common for the process to be repeated several times to achieve a level roll orientation. If bubble levels are being used to determine a level orientation, it is common knowledge that a bubble between the lines on a bubble level has an error range of 2-3 degrees. A significant error amount as it relates to RVs and can cause doors, plumbing and other objects and systems within the RV to not operate properly.

Once the roll orientation is level, the pitch orientation leveling operation must be completed. Typically, the bubble level mounted to the side of the RV will be used in this process. In the case of a towable RV, the process generally involves using the jack(s) on the front of the RV to raise or lower the front of the RV until a level position is achieved. Since the upward travel of the jack(s) is limited, it is sometimes required to place blocks or some other object under the jack to enable the jack(s) to raise the front of the RV high enough to achieve a level position. Placing blocks or other objects under the jack(s) requires the RV to be reattached to the tow vehicle, the jack(s) raised, blocks or objects placed under the jack(s), the jack(s) lowered onto the blocks or objects and then released from the tow vehicle. In the case of a drivable RV, the same iterative process used to level the roll of the RV is necessary to level the pitch of the RV. The process may require many attempts, as in the case of leveling the roll of the RV.

As such, a need exists for a system for an easy and efficient leveling of a recreational vehicle that does not require many attempts to achieve a level balance of the recreational vehicle in both the pitch and the roll directions.

### BRIEF DESCRIPTION OF THE DRAWINGS

FIG. 1 illustrates a side view of a vehicle with a leveling system;

FIG. 2 illustrates a front view of the vehicle with the leveling system;

FIG. 3 illustrates a bottom view of the vehicle with the leveling system;

FIGS. 4a-4c illustrate various jacks used with the leveling system;

FIG. 5 is a block diagram of a sensor device used with the leveling system;

FIG. 6 illustrates a smart device using the leveling system;

FIG. 7 illustrates the smart device displaying information about the vehicle;

FIG. 8 illustrates the smart device displaying further information about the vehicle;

FIG. 9 illustrates a side view of the vehicle during leveling calibration to determine a reference;

FIG. 10 illustrates the smart device displaying information about calibrating the reference;

FIG. 11 illustrates a side view of the vehicle during leveling;

FIG. 12 illustrates the smart device displaying information about leveling the vehicle using the calibration reference;

FIG. 13 illustrates the smart device displaying feedback to the user about leveling the vehicle; and

FIG. 14 is a flow chart of the leveling system using the calibration reference.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

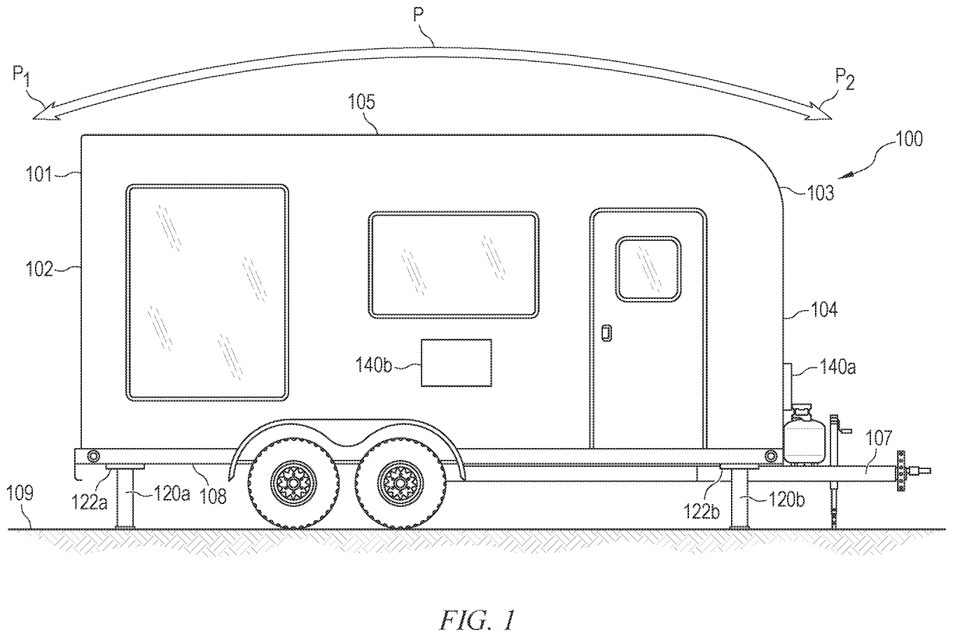

A necessary practice in the use of an RV relates to leveling relative to the two main axes of the RV: pitch being defined as the angle of the RV from front to back and roll being defined as the angle of the RV from side to side. When adjusting the pitch, RV 100 can be adjusted in pitch rotational directions P depends on the inclination of the RV from front-to-back, as shown in FIG. 1. Assume a reference point 101 on back section 102 and a reference point 103 on front section 104. Reference point 101 is the same relative position as reference point 103, e.g., equidistance from top surface 105 or equidistance from bottom surface 108 of RV 100. RV tongue section 107 is attached to front section 104 for towing. If RV 100 is pitch inclined so that reference point 101 is further from ground 109 than reference point 103, then the pitch of RV 100 can be adjusted in the direction of arrow point P₁ to achieve a level pitch state. If RV 100 is pitch inclined so that reference point 101 is closer to ground 109 than reference point 103, then the pitch can be adjusted in the direction of arrow point P₂ to achieve a level pitch state.

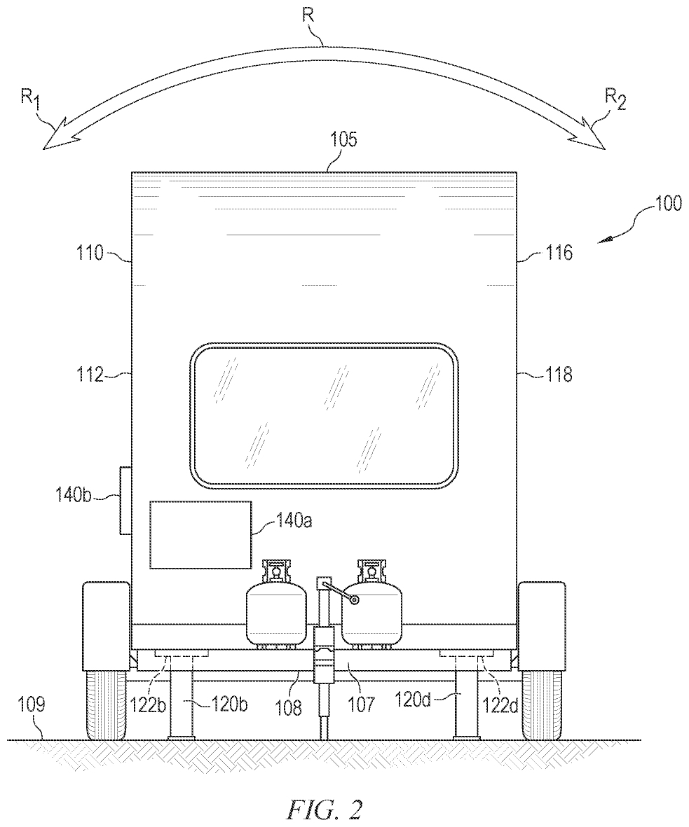

Similarly, as shown in FIG. 2, assume a reference point 110 on side section 112 and a reference point 116 on side section 118. Reference point 110 is the same relative position as reference point 116, e.g., equidistance from top surface 105 or equidistance from bottom surface 108 of RV 100. When adjusting the roll, RV 100 can be adjusted in roll rotational directions R depending on the inclination of the RV from side-to-side. If RV 100 is roll inclined so that reference point 110 is further from ground 109 than reference point 116, then the roll of RV 100 can be adjusted in the direction of arrow point R₁ to achieve a level roll state. If RV 100 is roll inclined so that reference point 110 is closer to ground 109 than reference point 116, then the roll can be adjusted in the direction of arrow point R₂ to achieve a level roll state.

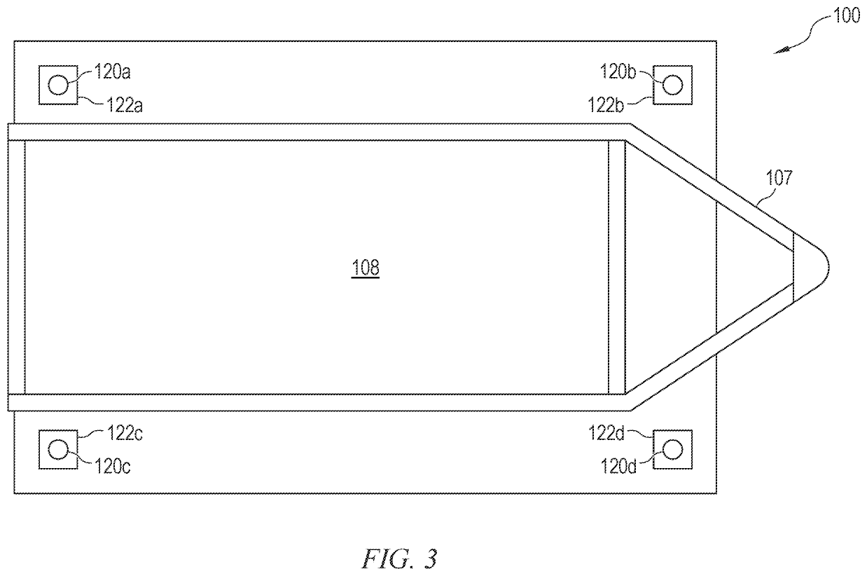

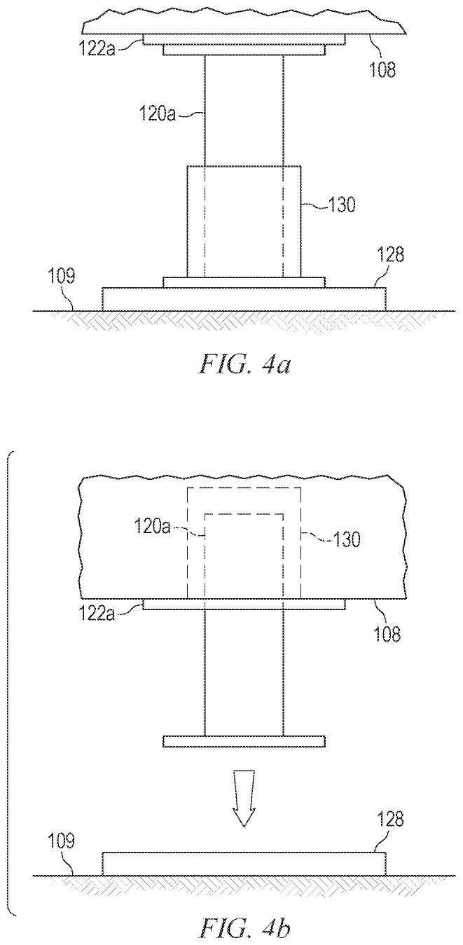

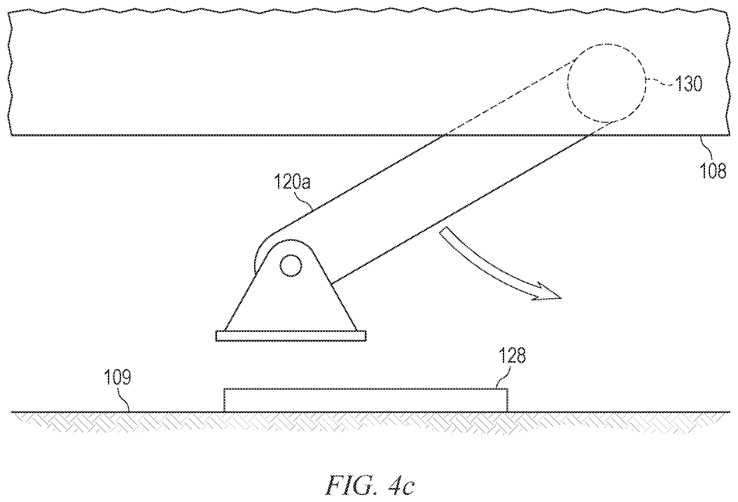

RV 100 makes use of four or more jacks 120a, 120b, 120c, and 120d at support points 122a, 122b, 122c, and 122d on bottom surface 108, respectively, as shown in FIGS. 1 and 2. FIG. 3 is a bottom view of RV 100 with jacks 120a-120d and support points 122a-122d. Jack 120a is designated as the left rear (LR) jack, jack 120b is designated as the left front (LF) jack, jack 120c is designated as the right rear (RR) jack, and jack 120d is designated as the right front (RF) jack. Jacks 120a-120d can be implemented in a variety of forms. Jacks 120a-120d can be hand-held and placed between support points 122a-122d and ground 109 or support blocks 128, as shown in FIG. 4a. Jacks 120a-120d can be mounted within RV 100 and move vertically downward to ground 109 or support blocks 128, as shown in FIG. 4b. Jacks 120a-120d can be mounted within RV 100 and rotate downward toward ground 109 or support blocks 128, as shown in FIG. 4c. Jacks 120a-120d can be hand-operated or placed in motion or operated by motor 130. Motor 130 can be screw-driven, hydraulic, electric, magnetic, or other type of prime mover.

Returning to FIG. 1, one or more sensor devices 140 are mounted to RV 100. Sensor device 140 can be mounted to back section 102, front section 104, side section 112, and/or side section 118. Sensor device 140 can be mounted inside RV 100 or within the framework thereof. In one embodiment, sensor device 140 is mounted to side section 112. In another embodiment, sensor device 140a is mounted to front section 104 and sensor device 140b is mounted to side section 112.

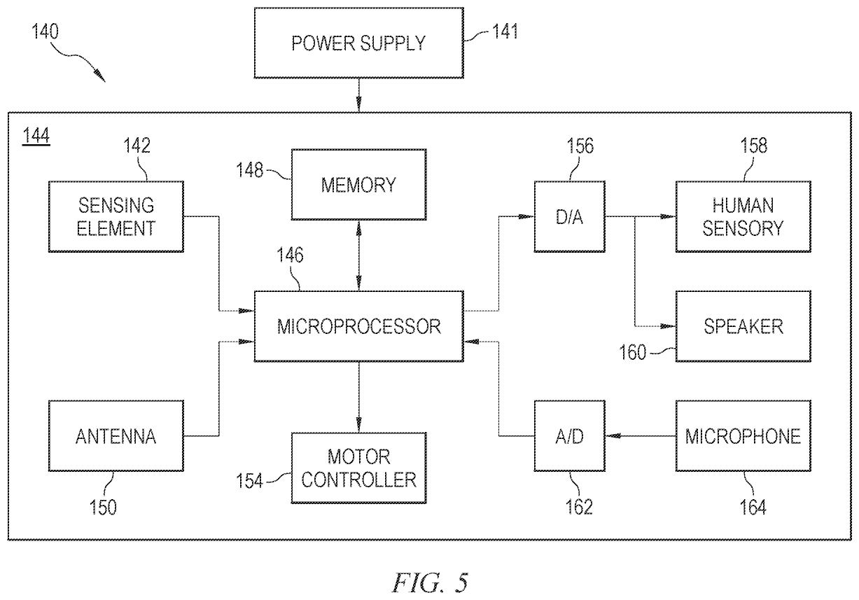

FIG. 5 illustrates further detail of sensor device 140. Sensing element 142 is mechanically and electrically connected to printed circuit board (PCB) 144. Power supply 141 provides electric power to all components of PCB 144. Power supply 141 can be a battery or other DC power source. Sensing element 142 can be one or more digital accelerometers, one or more digital gyroscopes, global positioning system (GPS) sensor, and other sensors required for accomplishing the desired position sensing and leveling functionality of for RV 100. Sensing element 142 is capable of monitoring multiple axis of orientation, for example, an X-axis, a Y-axis, and a Z-axis that are used to determine movement and position of RV 100 and other leveling data. For the present explanation, the X-axis of sensor device 140 is the pitch, the Y-axis of the sensor device is the roll, and the Z-axis of the sensor device is the vertical alignment of RV 100. The orientation of sensor device 140 relative to the front, the rear, passenger side or drive side upon or after installation can be noted using the software application on either PCB 144 of sensor device 140 or smart device 170 so that an appropriate axis can be assigned to determine the pitch angle measurement and an appropriate axis can be assigned to determine the roll angle measurement. The orientation of sensor device 140 can be identified or assigned relative to the vehicle. The mobile smart device 170 software application may have a screen designed to define the installed orientation of sensor device 140 so that data from the appropriate axes can be used for pitch and roll calculations.

Microprocessor 146 is mechanically and electrically connected to PCB 144 and sends and receives electrical signals with respect to sensing element 142. Memory 148 is mechanically and electrically connected to PCB 144 and sends and receives electrical signals with respect to microprocessor 146. Microprocessor 146 reads and writes to memory 148 and/or applications at the edge or cloud base. Antenna 150 is mechanically and electrically connected to PCB 144 and sends and receives electrical signals with respect to sensor element 142 and microprocessor 146. Antenna 150 can process Bluetooth, cellular, WiFi, or other wireless communications. Smart device 170 includes software that is capable of communicating with PCB 140 of sensor device 140, storing information obtained from the PCB of sensor device 140, manipulating the information obtained from the PCB of sensor device 140 and/or user input related to the inclination and/or orientation of RV 100, control of jacks 120a-120d, and displaying of information obtained from the PCB of sensor device 140 and user input, as well as information generated from the information obtained from the PCB of sensor device 140 and/or the user input related to the inclination and/or orientation of RV 100. PCB 144 and RV 100 can operate with other types of sensors.

Motor controller 154 is mechanically and electrically connected to PCB 144 and sends and receives electrical signals with respect to microprocessor 146 to control motor 130 for jacks 120a-120d. Digital-to-analog (D/A) converter 156 is mechanically and electrically connected to PCB 144 and sends and receives electrical signals with respect to microprocessor 146 to control human sensory output 158 and speaker 160. Analog-to-digital (A/D) converter 160 is mechanically and electrically connected to PCB 144 and sends and receives electrical signals with respect to microprocessor 146 to control microphone 162.

Microprocessor 146 contains software and firmware to allow for the processing of data and performing calculations related to the desired functionality of the RV leveling system. Sensor device 140 can be battery powered or use other means of power, such as AC or DC connections. Sensor device 140 is typically contained within a housing or enclosure for environmental protection and isolation from other damage.

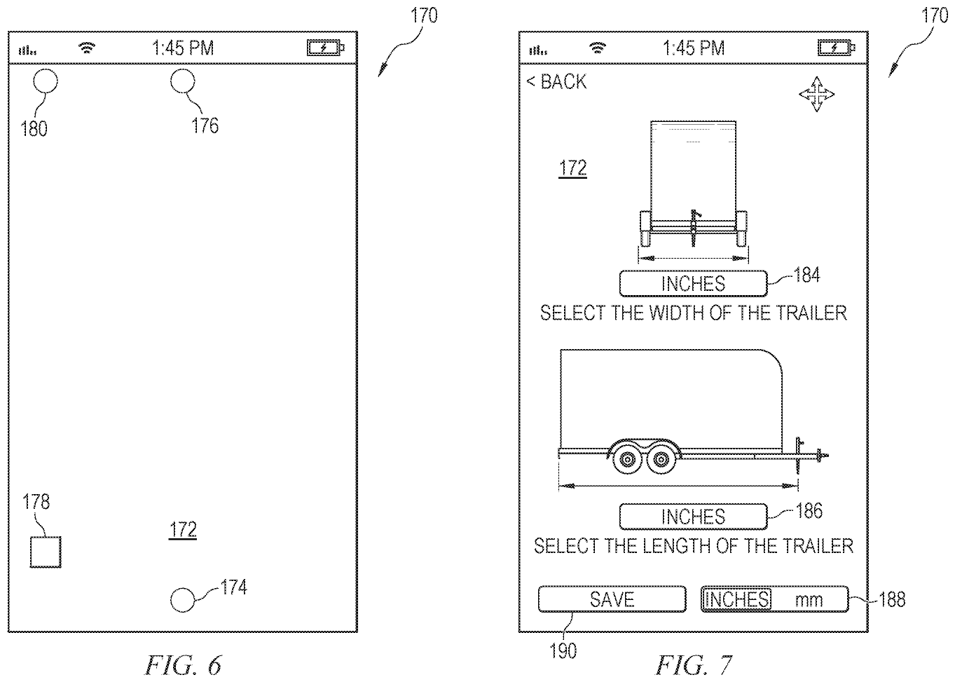

FIG. 6 illustrates smart device 170, such as a smart mobile phone or tablet, with display and touch screen 172 to communicate with and otherwise interact with sensor device 140 via graphical and audible commands. Smart device 170 has microphone 174 for the user to provide audible commands and feedback and speaker 176 for the user to hear audible commands and feedback. Smart device 170 also has vibrator 178 for the user to receive haptic commands and feedback and light source 180 for the user to observe sensory commands and feedback. Smart device 170 communicates with sensor device 140 by sending and receiving signals through antenna 150.

Smart device 170 provides a number of user interface screens to provide input to sensor device 140 and receive feedback from the sensor device. The user controls and interacts with sensor device 140 through software applications on smart device 170. For example, the software application on smart device 170 can prompt the user to enter information such as the measurements of RV 100, e.g., the length and width of RV 100, that can be used during calibration. In FIG. 7, button 184 on display and touch screen 172 allows the user to enter a width of RV 100 as measured from the outside of a first wheel, or tire, on a first side of the RV to the outside of a second wheel, or tire, on a second side of the RV along an axle of the

RV. Button 186 allows the user to enter a length of RV 100 as measured from back section 102 to front section 104, or from a center point of the rear axle to RV tongue section 107. Button 188 allows the user to select between imperial or metric measurements. Button 190 allows the user to save the measurements upon transfer of the information from smart device 170 through antenna 150 to memory 148.

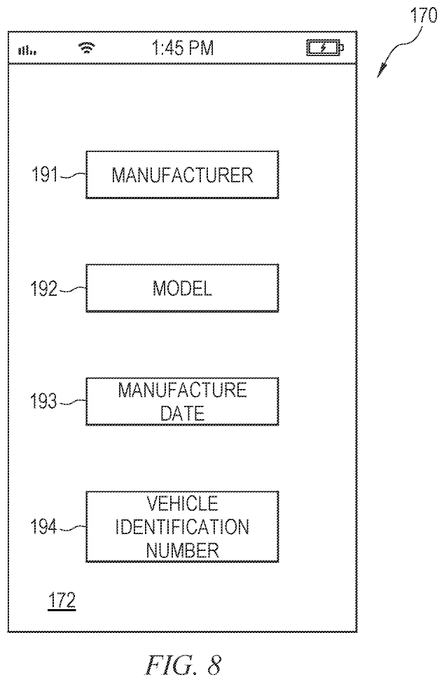

In another example, the software application on smart device 170 can prompt the user to enter information about RV 100, e.g., manufacturer, model, and manufacture date, that can be used during calibration. In FIG. 8, button 191 on display and touch screen 172 allows the user to enter the RV manufacturer. Button 192 allows the user to enter the RV model. Button 193 allows the user to enter manufacture date. Button 194 allows the user to enter the vehicle identification number. Smart device 170 software applications can display lists of various makes and models of RV 100, including pictures and other information, or read a QR code permanently attached to the RV to fill in all necessary information. The makes and models of RVs can be available by internet search. The screen can allow the user to scroll the list or can provide a search mechanism that allows the user to find the exact RV in question or shorten the list of RVs to be viewed. In this manner, the user would simply select the make and model of the RV from a list contained within the mobile smart device software application of smart device 170. In some embodiments, the length and width measurements in FIG. 7 could be pre-programmed for various makes and models of RVs.

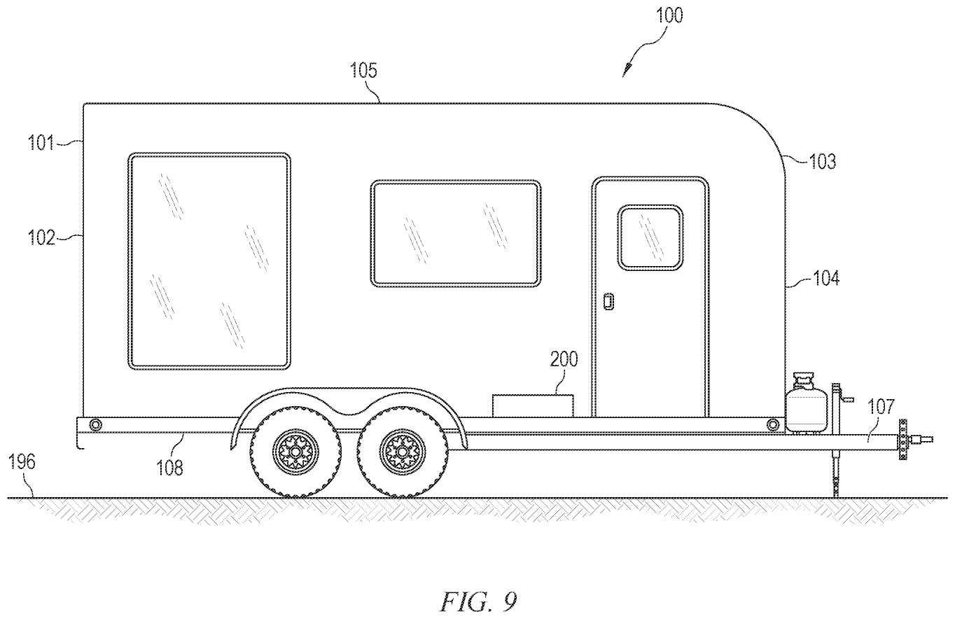

As a key feature, smart device 170 can be used to perform a calibration for absolute level or flatness. In one embodiment and as a first example, RV 100 is parked in a location known to be absolute flat in the pitch axis and roll axis. The absolute flatness location can be the shop floor of the RV dealer, user's garage or parking area, or other location known to be absolute flat. FIG. 9 shows RV 100 parked on surface 196, known to be absolute flat in the pitch axis and roll axis. As an option, high precision level measuring equipment 200 can confirm absolute flatness state of RV 100 in the pitch axis and roll axis. Level measuring equipment 200 may use lasers to confirm absolute flatness state of RV 100. In other embodiments, level measuring equipment 200 can be a high precision bubble level.

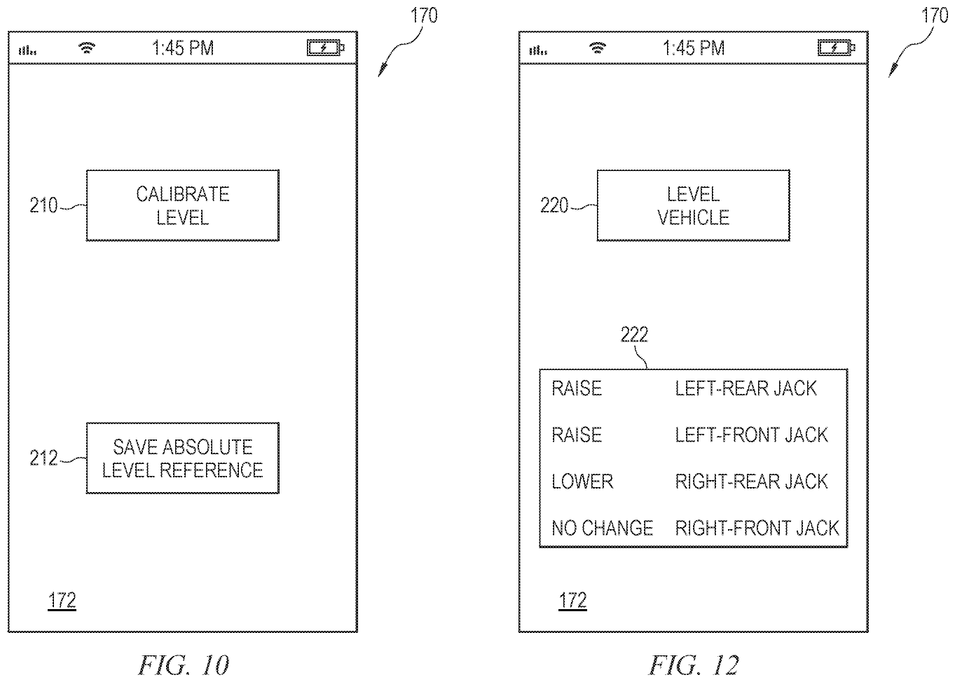

FIG. 10 shows smart device 170 performing a leveling calibration. Button 210 allows the user to select the calibrate level function. Once RV 100 is located or otherwise set to a position believed to be absolute flat in the pitch axis and roll axis, as described in FIG. 9, the user selects calibrate function button 210. Sensing element 142 reads a three-dimensional calibration reference position with x-axis angle X₀, y-axis angle Y₀, and z-axis angle Z₀, all in degrees. X₀ is the pitch reference, Y₀, is the roll reference, and Z₀ is the vertical reference. The calibration reference positions can be taken from level measuring equipment 200 or sensor device 140. In the present example, using absolute level surface 196, X₀=Y₀=Z₀=0.0. The user then selects save absolute flatness reference button 212. Smart device 170 stores an absolute flatness calibration reference positions X₀, Y₀, and Z₀ in memory 148 and/or internally in the smart device memory.

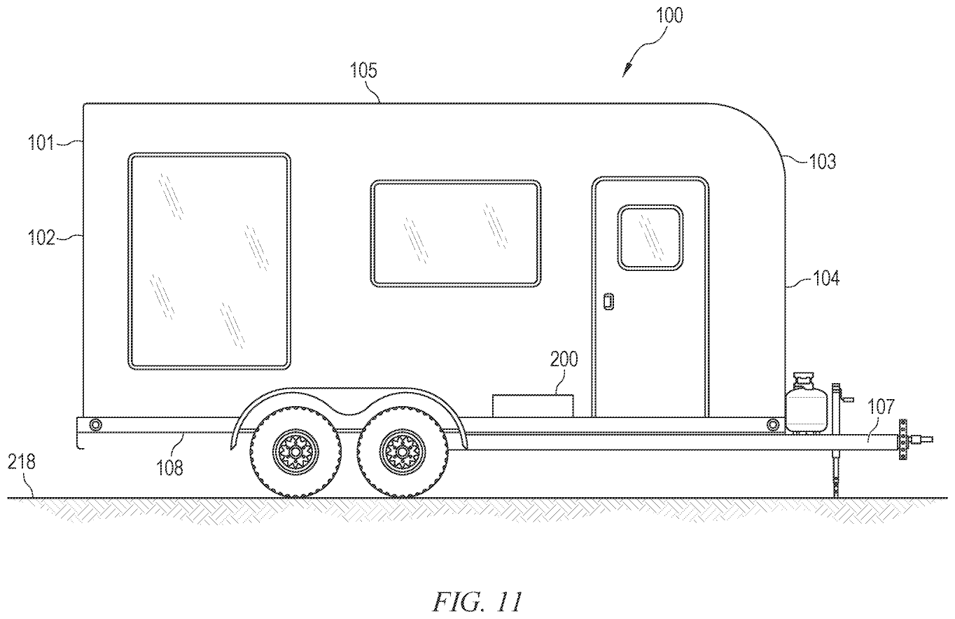

Once the calibration has been performed, the software application or microprocessor 146 can be used to determine the change in roll and the change in pitch needed for the given RV 100 based on measurements from sensor device 140 at any given location. Assume RV 100 has moved to a new location, this time to a camp site or other locale that is likely not level. In FIG. 11, RV 100 is located at a local camp site on likely non-level ground 218. Smart device 170 is used to level RV 100 in the new camp location. FIG. 12 shows smart device 170 performing a leveling process. Button 220 allows the user to select the RV level process. Sensor device 140 receives the command to perform a leveling process from smart device 170 through antenna 150. Sensor device 140 takes measurements for the local level state using sensing element 142, including x-axis angle X₁, y-axis angle Y₁, and z-axis angle Z₁, all in degrees. Next, the calibration reference measurements X₀, Y₀, and Z₀ are subtracted from the local measurements X₁, Y₁, and Z₁, respectively, to determine a set of difference measurements as follows:

X₁−X₀=x-axis difference angle X_{D} in the pitch axis

Y₁−Y₀=y-axis difference angle Y_{D} in the roll axis

Z₁−Z₀=z-axis difference angle Z₀ in the vertical axis

As an example, assume X₁=5.0°, Y₁=−3.5°, Z₁=1.0° in the camp location.

X_{D}=X₁−X₀=5.0°−0.0°=5.0°

Y_{D}=Y₁−Y₀=−3.5°−0.0°=−3.5°

Z_{D}=Z₁−Z₀=1.0°−0.0°=1.0°

The above calculations can be performed in sensor device 140 or smart device 170. Given the difference angles X_{D}, Y_{D}, and Z_{D}, and the goal to make the difference angles all zero, the movement of RV 100 in the pitch axis P and roll axis R in FIGS. 1 and 2, is determined to achieve absolute flatness. For example, if X_{D} is 5.0°, then the LF jack 120b and RF jack 120d may be raised or lowered or the LR jack 120a and RR jack 120c may be raised or lowered, depending on the pitch angle orientation. If Y_{D} is −3.5°, then then the LF jack 120b and LR jack 120a may be raised or lowered or the RR jack 120c and RF jack 120d may be raised or lowered, depending on the roll angle orientation. If Z_{D} is 1.0°, then jacks 120a-120d can be raised or lowered, depending on the vertical angle orientation.

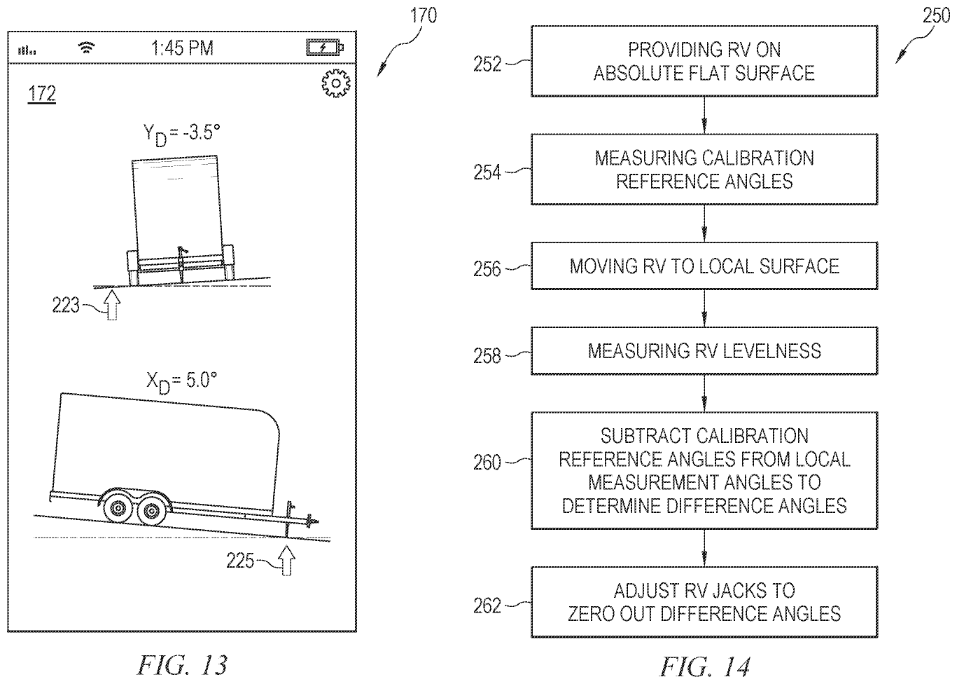

Sensor device 140 provides feedback of the difference angles in order and makes adjustments to jacks 120a-120d to level RV 100, in accordance with the calibration reference. In one embodiment, the user receives a visual representation of RV 100 on smart device 170 showing the orientation of the RV, given the difference angles X_{D}, Y_{D}, and Z_{D}. FIG. 13 shows a visual representation of RV 100 with X_{D} at 5.0° and Y_{D} at −3.5° on smart device 170. The display further provides suggestions or feedback of how much and in which direction to adjust each jack 120a-120d, as shown with arrows 223 and 225 in FIG. 13. The user can make adjustments to jacks 120a-120d according to difference angles X_{D}, Y_{D}, and Z_{D} by hand or using smart device 170 to control the jacks with motor controller 154 and motor 130. In another embodiment, display 172 shows suggestions or feedback of how much and in which direction to adjust each jack 120a-120d, as shown in block 222 of FIG. 12. In another embodiment, sensor device 140 and/or smart device 170 controls jacks 120a-120d automatically using motor controller 154 and motor 130 to make adjustments to jacks 120a-120d according to difference angles X_{D}, Y_{D}, and Z_{D}. That is, given difference angles X_{D}, Y_{D}, and Z_{D}, sensor device 140 and/or smart device 170 cause jacks 120a-120d to move by way of motor controller 154 and motor 130 in a direction and distance to zero out the difference angles.

In another embodiment, the user receives feedback from audible instructions from speaker 160 or speaker 176 of how much and in which direction to adjust each jack 120a-120d to zero out the difference angles. The software application on smart device 170 can also provide audible or other human sensory feedback. FIG. 5 illustrates PCB 144 in sensor device 140 that could provide the audible or other human sensory feedback. In one embodiment, based on the leveling data from sensor device 140, microprocessor 146 generates a series of beeps or other audible tone from speaker 160. The audible tones can originate from sensor device 140 or smart device 170. The audible tone originates from an audible table stored in memory 148. The audible tone is routed through D/A converter 156 to speaker 160 for audible transmission to the user. The base frequency tone of the audible tone is selectable. The frequency of the audible tone increases or decreases with the nature of the feedback. For example, the audible tone will have a slower frequency, say 1 tone per second, when RV 100 is well off-level, and move to higher frequency, say 5-20 tones per second, as the RV approaches a level state. The progression in frequency can be linear with the movement towards a level state. Jacks 120a-120d are adjusted, manually or automatically, in response to audible or other human sensory feedback to zero out the difference angles and level RV 100.

In another type of audible feedback, the software application on smart device 170 can provide voice feedback. For example, the software application on smart device 170 can provide various computer-generated words or phrases to be broadcast from speaker 160 or speaker 176. The computer-generated words or phrases would be indicative of the nature of the feedback. For example, the computer-generated words from speaker 160 or speaker 176 may say “you are 2 inches high to the right front of the RV, lower the right front by 2 inches.” The computer-generated words may say “you are 1 inch low to the left rear of the RV, raise the left rear by 1 inch.” The computer-generated words may say “pause and place 1 inch support under the left front tire or jack.” The computer-generated words provide directions and recommendations to most efficiently level RV 100. The directions and recommendations would be based on the leveling data from sensor device 140, as well as calculations within microprocessor 146 including direction and distance to zero out the difference angles, to determine what should be the next physical step the user should undertake to level RV 100 as efficiently as possible. The software tells the user what needs to be done and where the action needs to occur to properly level the RV. The software operates as a real-time leveling coach or advisor to assist the user. Jacks 120a-120d are adjusted, manually or automatically, in response to audible or other human sensory feedback to zero out the difference angles and level RV 100. Memory 148 includes a voice table of predetermined words or phrases for microprocessor 146 to select from, based on the indicated action. D/A converter 156 converts the digital information to analog signal for speaker 160.

Smart device 170 can also provide human sensory feedback 158, such as light or haptic feedback, through D/A converter 156. The user can observe light from light source 180 in smart device 170 or feel vibrations, taps, or pulses from vibrator 178 in the smart device as human sensory feedback. When providing human sensory feedback, an icon can be displayed on the smart device screen. For example, audible feedback can be an ear icon.

Microprocessor 146 can also receive feedback from the user through microphone 174. The user may provide relevant information to microprocessor 146, such as “it is raining and the RV and jacks are resting on soft ground”, or “the RV appears to be too high in the front”, or “the ground has a 5-degree slope front to back”, or “pause leveling process” or “ready to continue.” The user can ask questions or make statements to microprocessor 146, such as “can you repeat the last instruction”, or “how is the left front”, or “what do I need to do next”, or “let's restart leveling sequence.” The software will interpret and convert the user's words using voice recognition into corresponding digital communication. The directions and recommendations would be based on the leveling data from sensor device 140, as well as calculations within microprocessor 146 including direction and distance to zero out the difference angles, to determine what should be the next physical step the user should undertake to level RV 100 as efficiently as possible. Jacks 120a-120d are adjusted, manually or automatically, in response to audible or other human sensory feedback to zero out the difference angles and level RV 100.

The software application on smart device 170 is capable of processing artificial intelligence (AI) to enhance the communication between the user and leveling system. The AI is two-way or interactive in that the software can provide audible or human sensory feedback to the user, and the user can provide communication to the software.

Smart device 170 can process data directly from the accelerometer and gyro in sensing element 142. For example, if the accelerometer and gyro data already have been processed into “½ inch”, that “½ inch” information could be directly used to activate the sound/haptics/light functions versus using accelerometer readings directly as the App is doing today.

Once the adjustments are made to jacks 120a-120d, the user selects button 220 to recheck level. Sensor device 140 again receives the command to perform a leveling process from smart device 170 through antenna 150. Sensor device 140 takes pitch and roll measurements using sensing element 142, including X₁, Y₁, and Z₁. Next, the calibration reference measurements X₀, Y₀, and Z₀ are subtracted from the new local measurements X₁, Y₁, and Z₁, respectively, to determine a new set of difference measurements X_{D}, Y_{D}, and Z_{D}. If the new differences angles are still off zero, additional adjustments are made to jacks 120a-120d using the new difference angles, with the goal being to zero out the difference angles, as described above. If the new difference angles are substantially zero, then leveling is complete.

In some embodiments, smart device 170 can be used to perform a calibration for non-zero surfaces in terms of levelness. In this case, the calibration reference angles X₀, Y₀, and Z₀ may not be zero, as surface 196 may not be absolute flat, as in FIG. 9. The location can be the shop floor, user's garage or parking area, or other location that is not necessarily flat. In this case, the same process is used to save the non-zero calibration reference angles X₀, Y₀, and Z₀, move RV 100 to a new location, take local measurements X₁, Y₁, and Z₁, subtract references angles from local measurement, and adjust jacks 120a-120d to zero out the difference angles. In some embodiments, multiple sensor devices like 140a and 140b can be used to calibrate the reference angles X₀, Y₀, and Z₀ and take local measurements X₁, Y₁, and Z₁. The multiple sensor devices 140a-140b can be used in combination or as an average for the flatness setup.

In another embodiment, RV 100 can be releveled at any time with smart device 170 starting with level vehicle button 220 in FIG. 12. Smart device 170 can provide notice of loss of level from sensor device 140 prompting a releveling procedure.

In another embodiment, in addition to calibrating for an absolute level position, a hitch pitch calibration reference may be taken when tongue section 107 is raised sufficiently high to provide clearance to hitch and unhitch the tow vehicle. In that case, the process of subtracting the hitch pitch calibration reference angles from the local measurement and adjusting jacks 120a-120b or tongue section 107 to zero out the difference angles will provide the requisite separation or clearance between the two vehicle ball and tongue socket. This will simplify and increase the efficiency of detaching and reattaching the tow vehicle to RV 100.

As stated above, a software application in the form of a non-transitory computer readable medium can be provided that comprises computer executable instructions embodied in a computer readable medium that, when executed by a processor of a computer, control the computer to perform the steps similar to the method, generally designated 250, described above. For example, as shown in FIG. 14, RV 100 is located on an absolute flat surface in step 252. The non-transitory computer readable medium can perform step 254 of measuring calibration reference angles. In step 256, RV 100 is located on a local surface. In step 258, RV levelness is measured on the local surface. In step 260, the calibration reference angle is subtracted from the local measurement angles to determine a difference angle. In step 262, the jacks are adjusted to zero out the difference angle and level the RV.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole and in part. Furthermore, those of ordinary skill in the art will appreciate that the foregoing description is by way of example only and is not intended to limit the present subject matter.

What is claimed:

1. A vehicle leveling system, comprising:
a sensor for sensing a reference state of a vehicle and a local level state of the vehicle, wherein the reference state is subtracted from the local level state to determine a difference angle; and
a smart device in communication with the sensor providing feedback to adjust orientation of the vehicle as to zero out the difference angle and level the vehicle.

2. The vehicle leveling system of claim 1, wherein the feedback is an audible or human sensory feedback to a user.

3. The vehicle leveling system of claim 1, further including a plurality of jacks to level the vehicle by zeroing out the difference angle.

4. The vehicle leveling system of claim 3, wherein the jacks are controlled by the smart device or sensor.

5. The vehicle leveling system of claim 1, wherein the reference state is absolute flat.

6. The vehicle leveling system of claim 1, wherein the sensor includes a gyroscope providing multiple angles of orientation.

7. A vehicle leveling system, comprising:
a sensor for sensing a reference state of a vehicle and a level state of the vehicle, wherein the reference state is subtracted from the level state to determine a difference angle; and
a smart device in communication with the sensor to zero out the difference angle and level the vehicle.

8. The vehicle leveling system of claim 7, wherein the smart device provides feedback to adjust orientation of the vehicle as to zero out the difference angle and level the vehicle.

9. The vehicle leveling system of claim 8, wherein the feedback is an audible or human sensory feedback to a user.

10. The vehicle leveling system of claim 7, further including a plurality of jacks to level the vehicle by zeroing out the difference angle.

11. The vehicle leveling system of claim 10, wherein the jacks are controlled by the smart device or sensor.

12. The vehicle leveling system of claim 7, wherein the reference state is absolute flat.

13. The vehicle leveling system of claim 7, wherein the sensor includes a gyroscope providing multiple angles of orientation.

14. A method of leveling a vehicle, comprising:
providing a sensor for sensing a reference state of a vehicle and a level state of the vehicle, wherein the reference state is subtracted from the level state to determine a difference angle; and
providing a smart device in communication with the sensor to zero out the difference angle and level the vehicle.

15. The method of claim 14, wherein the smart device provides feedback to adjust orientation of the vehicle as to zero out the difference angle and level the vehicle.

16. The method of claim 15, wherein the feedback is an audible or human sensory feedback to a user.

17. The method of claim 14, further including providing a plurality of jacks to level the vehicle by zeroing out the difference angle.

18. The method of claim 17, wherein the jacks are controlled by the smart device or sensor.

19. The method of claim 14, wherein the reference state is absolute flat.

20. The method of claim 14, wherein the sensor includes a gyroscope providing multiple angles of orientation.
